(19) United States
(12) Patent Application Publication
(10) Pub. No.: US 2011/0022529 A1
(43) Pub. Date: Jan. 27, 2011

(54) SOCIAL NETWORK CREATION USING IMAGE RECOGNITION

(76) Inventors: Fernando Barsoba, Research Triangle Park, NC (US); Al Chakra, Research Trangle Park, NC (US)

Correspondence Address: MOORE & VAN ALLEN, PLLC For IBM, P.O. Box 13706, Research Triangle Park, NC, 27709, US

(21) Appl. No.: 12/507,360

(22) Filed: Jul. 22, 2009

(51) Int. Cl. G06Q 99/00; G06K 9/00; G06F 17/30

(52) U.S. Cl. 705/319; 382/100; 707/E17.108; 707/E17.032

(57) ABSTRACT

A method for dynamically creating a social network using image recognition may include performing image recognition analysis on an image and determining selected information based on the image recognition analysis. A new social network may then be created from the selected information.

### BACKGROUND

The present invention relates to the Internet and online social networks, and more particularly to a system and method for dynamically creating a social network using image recognition.

Networks of individuals or social networks online where individuals can share common interests, can meet and exchange information are becoming very popular and useful for sharing information. Examples of information that may be shared may include reviews on products, services, events, restaurants, stores, vacation destinations, and other items that may be of common interest. Forming such networks of individuals with common interest can represent a challenge. There may be certain information that a person is interested in, such as a potential geographic location for a vacation or information for some other purposes. There may be specific information about this geographic location in which the user has an interest or the user may have particular interests that only certain other people may have knowledge of.

### BRIEF SUMMARY

In accordance with an aspect of the present invention, the content of a picture or photograph and its metadata uploaded by a user may be analyzed to obtain information, such as geographic information or other information. The geographic information or other information may be compared or matched to pictures or information from others stored on a network or in public repositories. A social network may be established between the user and other individuals based matches between the pictures and/or information.

In accordance with an aspect of the present invention, a method for dynamically creating a social network using image recognition may include performing image recognition analysis on an image and determining selected information based on the image recognition analysis. A new social network may then be created from the selected information

In accordance with another aspect of the present invention, a system for dynamically creating a social network using image recognition may include a server and an image recognition engine stored on the server and operable on the server to perform image recognition analysis on an image. The image recognition engine may be adapted to compare the image to other images stored on a network to find other images related to the image A module may compile a list of persons associated with each other image found by the image recognition engine that is related to the image. Another module may create a new social network from the list of persons associated with each other image found by the image recognition engine.

In accordance with a further aspect of the present invention, a computer program product for dynamically creating a social network using image recognition may include a computer readable storage medium having computer readable program code embodied therewith. The computer readable program code may include computer readable program code configured to perform image recognition analysis on an image. The computer readable program code may additionally include computer readable program code configured to determine selected information based on the image recognition analysis. The computer readable program code may further include computer readable program code configured to create a new social network from the selected information.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for dynamically creating a social network using image recognition in accordance with an embodiment of the present invention.

FIG. 2 is a block schematic diagram of an example of a system for dynamically creating a social network using image recognition in accordance with another embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

As will be appreciated by one of skill in the art, aspects of the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other device to cause a series of operational steps to be performed on the computer, other programmable apparatus, or device to produce a computer implemented process such that the instructions which execute on the computer or other programmable apparatus provide processes for implementing the functions/acts specified in the flowchart and/or block diagram block or blocks.

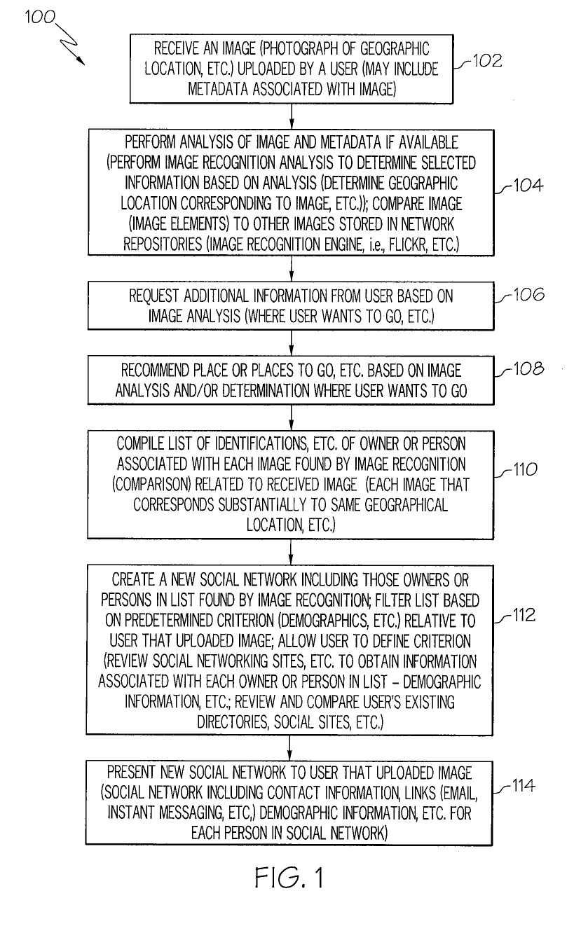

FIG. 1 is a flow chart of an example of a method 100 for dynamically creating a social network using image recognition in accordance with an embodiment of the present invention. In block 102 an image may be received. The image may be a photograph of a geographic location or some other image. The image may be uploaded by a user. Metadata associated with the image may also be uploaded. The metadata may include such information as an identity of the image, the geographic location of the image, key or important features or elements within the image or other information that may be beneficial in creating a social network as described herein. If the image is of a geographic location, the metadata may include Global Position System (GPS) information or location information obtained by some other technology, such as by triangulation in a cellular telephone network or other positioning or location means.

In block 104, analysis may be performed on the image and metadata, if available, to determine selected information based on the analysis, such as geographic location information or other information of interest such as key features or elements of the image or the like. The analysis may include image recognition analysis in order to compare the image or elements of the image to other images that may be stored on a network, such as the Internet or other network, or that may be stored in repositories or storage devices on the network. An image recognition engine may be used to perform the image analysis. Examples of network repositories for storing images and related information, such as metadata may include Flickr, Google Picassa, or similar online services. Flickr is a trademark of Yahoo, Inc. in the United States, other countries or both. Google and Google Picassa are trademarks of Google, Inc. in the United States, other countries or both.

Examples of image recognition engines are described in U.S. Patent Publication 2006/0251292, entitled “System and Method for Recognizing Objects from Images and Identifying Relevancy Amongst Images and Information,” filed Oct. 7, 2005 by Gokturket et al., and U.S. Patent Publication No. 2006/0251338, entitled, “System and Method for Providing Objectified Image Renderings Using Recognition Information From Images,” also filed Oct. 7, 2005 by Gokturket et al., and U.S. Patent Publication No. 2007/0172155, entitled, “Photo Automatic Linking System and Method for Accessing, Linking, and Visualizing ‘Key-Face’ and/or Multiple Similar Facial Images Along with Associated Electronic Data Via a Facial Image Recognition Search Engine,” filed Jan. 19, 2007 by Guckenberger.

An embodiment of the present invention provides a content-based image retrieval (CBIR) feature. In block 104, selected information based on the image recognition analysis may be determined, such as the geographic location of the image or other information of interest that may be determined by performing the image recognition analysis on the received or uploaded image or images. A search may then be performed for other images stored on a network related to the received image.

In block 106, additional information may be requested from the user based on the image analysis. Accordingly, a relevance feedback feature, i.e., capturing a user's precise needs through iterative feedback and query refinement may be used to identify any key elements in the image recognition analysis. For example, the user may be requested to provide the geographic location where the user wants to go, what particular feature in the uploaded image that the user is interested in, or other aspect of the image that may be important in creating the user's specialized or ad hoc social network as described herein.

In block 108, the method 100 or system may recommend a place or places to go based on the image analysis and/or any information provided by the user in block 106, such as determining where the user wants to go or what the user may want to see or do.

In addition to the CBIR features of the embodiments of the present invention plus social networking as described herein, a trip advisor service may also be provided to give users suggestions based on interest, location, order of events and other sensory information that may be requested or uploaded by the user. For example, at any given point in a trip, such as a vacation or the like, the trip advisor service can greatly improve the accuracy of a user's interest based on social networking suggestions. These suggestions could come both from built-in relevance feedback where the user is presented a plurality of options asking for a meaning or what is of interest in a picture or photograph. For example, did the user intend to photograph a river or a mountain when the user uploaded the photo of a valley with both elements in the image or photograph? This feature may also facilitate matching with other users that took the same trip and were at the same place and have stored images or photographs and related information on the network.

The trip advisor may also help the user decide which destination to take next. For example, after the user has visited location A, the trip advisor may suggest a new place nearby based on the user's preferences. If the user seems to have an interest in outdoor activities as a result of uploaded pictures of landscapes may seem to indicate, the user may want to know about trails in the geographic area of interest or other points of possible interest. The trip advisor can provide additional choices to the user and create a trip with multiple options for selection by the user. The system or method 100 may also download comments, reviews, and overall experiences of others that have found themselves in the same situation or location.

In block 110, a list of identifications or other information of owners or of persons associated with each image found by image recognition or comparison related to the received or uploaded image may be compiled. For example, the identity and other information of the owner or person associated with each image that corresponds substantially to the same geographical location or is related to the same geographical location may be included in the compiled list.

In block 112, a new social network including those owners or persons in the list found by image recognition may be created. A network search may be performed to obtain demographic information and contact information associated with each person on the list for creating the new social network.

In block 112, the demographic information and contact information may be filtered based on predetermined criterion to create the new social network. The user associated with the received or uploaded image may be allowed to define the predetermined criteria for filtering the demographic information and contact information for creating the new social network. A graphical user interface (GUI) may be presented to the user for defining the predetermined criteria. For example, the user may be allowed to define an age range for filtering the list for creating the social network. The user may be permitted to define a geographic location of residence for filtering the list for creating the social network so that only individuals that live in the same country or speak the same language as the user are on the list. The user may be allowed to define other demographic criteria for filtering the list or the list may be filtered based on other criterion for creating the social network.

The list of persons may also be compared with any existing directory or directories of the user and any currently used social networks of the user to find any matches for creating the new social network.

In block 114, the new social network may be presented to the user that uploaded the image. The social network may include contact information, links, such as email, instant messaging or other means for contacting persons in the social network. Demographic information may also be provided for each person in the social network to facilitate the user selecting which individual or individuals to contact. For example, which individuals on the list to contact with regard to the geographic location where the user may be desiring to travel or to contact a specific person in the social network for some other purpose.

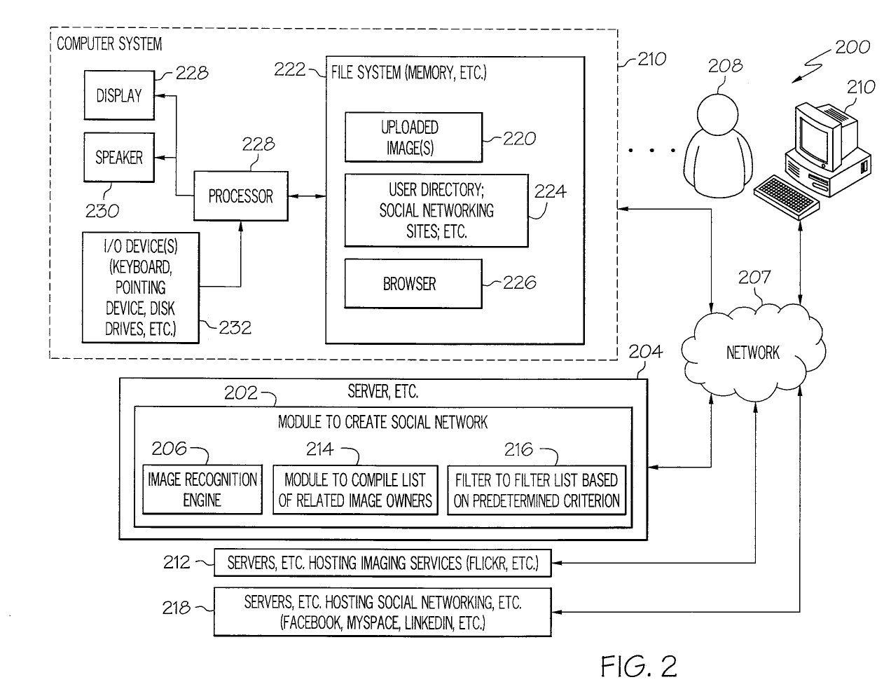

FIG. 2 is a block schematic diagram of an example of a system 200 for dynamically creating a social network using image recognition in accordance with an embodiment of the present invention. The method 100 of FIG. 1 may also be embodied in or performed by the system 200. The system 200 may include a module 202 for dynamically creating a social network. The module 202 may be stored on a server 204 or on a file system of the server 204. Portions of or all of the method 100 may be embodied in or performed by the module 202.

The module 202 may include an image recognition engine 206, similar to that previously described, to perform image recognition analysis on an image or images that may be uploaded by a user, such as user 208 using a computer system 210. An example of computer system 210 will be described in more detail below. The image recognition engine 206 may be adapted to compare the uploaded image to other images stored on a network 207 to find other images related to the uploaded image. The other images may be stored on other servers or similar devices, such as server 212 which may host an imaging service, such as Flickr, Google Picassa or similar imaging services.

The module 202 to dynamically create a social network may also include a module 214 to compile a list of persons associated with each other image found by the image recognition engine 206 that is related to the uploaded image. The module 202 to dynamically create a new social network may then create the social network from the list of persons associated with each of the other images found by the image recognition engine 206.

The module 202 may also include a filter 216 to filter the list of persons associated with each other image found by the image recognition engine 206 based on a predetermined relationship between the user and any persons in the list. Similar to that previously described with respect to the method 100, the user may be allowed to define parameters of the filter for filtering the list of persons in the social network.

In accordance with an aspect of the invention, the uploaded image may be a photograph of a geographic location. Metadata associated with the photograph may also be uploaded to the server 204 with the photograph. The image recognition engine 206 may be adapted to analyze the photograph and the associated metadata to obtain geographic information. The geographic information may be matched to other photographs or information stored on the network 207 by other users, such as on server 212 hosting an imaging service. The new social network may then be created including those persons or other users whose photographs or information matches the uploaded photograph and metadata of the user 208. The new social network may be based on travel and tourism interests or other interests based on results of the image recognition analysis.

Similar to that previously described, the social network may be created by searching on the network 207 for information related to other persons or users in the list that have stored images on the network 207 and that match or are related to the image or images uploaded by the user 208. Other servers 218 or the like hosting social networking services or similar service, such as Facebook, MySpace, LinkedIn and the like, may be searched for information and any commonality or relationship with the user. Facebook is a trademark of Facebook, Inc. and MySpace is a trademark of MySpace, Inc. in the United States, other countries, or both. LinkedIn is a trademark of LinkedIn Corporation in the United States, other countries, or both.

The user 208 may use a computer system 210 to access the server 204 and module 202 for creating the social network similar to that described herein. An image 220 or images may be stored on a file system 222 of the exemplary computer system 210 that may be uploaded to the module 202 for creating the social network or system 200 for creating the social network.

A user directory 224 or listing of social networking sites that the user 208 may have visited or used may also be stored on the file system 222. The user directory 224 social networking sites or other databases may be searched to find users in the list of related images based on a predetermined criterion that may have some relationship to the user similar to that previously described.

A web or Internet browser 226 may also be stored on the file system 222 for accessing the module to create the social network 202 and other services or servers via the network 207. The network 207 may be the Internet, an intranet or other private or proprietary network.

The computer system 210 may also include a display 228, a speaker system 230, and one or more input devices, output devices or combination input/output devices, collectively I/O devices 232. The I/O devices 232 may include a keyboard, pointing device, such as a mouse, disk drives and any other devices to permit a user, such as user 208, to interface with and control operation of the computer system 210 and to access or receive online content. The display 228 may present the online content received by the computer system 210. The speaker 230 may present any sounds associated with the online content.

Other embodiments of the present invention are not limited to only a server and the system and features described herein may be in one of many forms. Examples may include may include a client, configurations that support peer-to-peer communications, a wireless solution or other arrangements.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable other of ordinary skill in the art to understand the invention for various embodiments with various modifications as are suited to the particular use contemplated.

What is claimed is:

1. A method for dynamically creating a social network using image recognition, comprising:
performing image recognition analysis on an image;
determining selected information based on the image recognition analysis; and
creating a new social network from the selected information.

2. The method of claim 1, further comprising searching for other images stored on a network related to the image.

3. The method of claim 2, further comprising compiling a list of persons associated with each other image found by searching for other images.

4. The method of claim 3, wherein the new social network is created from the list of persons associated with each other image found by the image recognition analysis.

5. The method of claim 3, further comprising performing a network search to obtain demographic information and contact information associated with each person on the list for creating the new social network.

6. The method of claim 5, further comprising filtering the demographic information and contact information based on a predetermined criterion to create the new social network.

7. The method of claim 6, further comprising allowing a user associated with the image to define the predetermined criterion for filtering the demographic information and contact information for creating the new social network.

8. The method of claim 7, wherein allowing the user associated with the image to define the predetermined criterion comprises at least one of:
allowing the user to define an age range for filtering the list for creating the new social network;
allowing the user to define a geographic location of residence for filtering the list for creating the new social network; and
allowing the user to define other demographic criterion for filtering the list for creating the new social network.

9. The method of claim 5, further comprising comparing the list of persons with a user's existing directory and any currently used social network of a user to find any matches for creating the new social network.

10. The method of claim 1, further comprising presenting the new social network to a user associated with the image.

11. The method of claim 1, wherein receiving an image comprises:
receiving a photograph of a selected geographic location uploaded by a user; and
receiving metadata associated with the photograph of the selected geographic location.

12. The method of claim 11, further comprising:
performing image recognition analysis of the photograph of the selected geographic location;
comparing the image recognition analysis of the photograph to other photographs in a network repository to find other photographs of the selected geographic location;
compiling a list of persons associated with each other photograph of the selected geographic location; and
creating the new social network from the list of persons associated with each other photograph of the selected geographic location.

13. The method of claim 12, further comprising determining if any relationship exists between the user and the list of persons associated with each photograph in creating the new social network.

14. A system for dynamically creating a social network using image recognition, comprising:
a server;
an image recognition engine stored on the server and operable on the server to perform image recognition analysis on an image and wherein the image recognition engine is adapted to compare the image to other images stored on a network to find other images related to the image;
a module to compile a list of persons associated with each other image found by the image recognition engine that is related to the image; and
a module to create a new social network from the list of persons associated with each other image found by the image recognition engine.

15. The system of claim 14, further comprising a filter to filter the list of persons associated with each other image found by the image recognition engine based on a predetermined relationship between a user and any persons in the list.

16. The system of claim 14, wherein the image is a photograph of a geographic location uploaded to the server and wherein metadata associated with the photograph is uploaded to the server with the photograph, the image recognition engine being adapted to analyze the photograph and the associated metadata to obtain geographic information to be matched to other photographs stored on the network by other users to create the new social network, wherein the new social network is based on travel and tourism interests.

17. A computer program product for dynamically creating a social network using image recognition, the computer program product comprising:
a computer readable storage medium having computer readable program code embodied therewith, the computer readable program code comprising:
computer readable program code configured to perform image recognition analysis on an image;
computer readable program code configured to determine selected information based on the image recognition analysis; and
computer readable program code configured to create a new social network from the selected information.

18. The computer program product of claim 17, further comprising:
computer readable program code configured to search for other images stored on a network related to the image; computer readable program code configured to compile a list of persons associated with each image found by searching for other images, wherein the new social network is created from the list of persons associated with each image found by the image recognition analysis.

19. The computer program product of claim 18, further comprising computer readable program code configured to filter the list of persons associated with each image in response to there being a relationship between a user associated with the image and the person in the list.

20. The computer program product of claim 18, further comprising computer readable program code configured to allow a user to define predetermined criterion for filtering the list of persons for creating the new social network.
